(19) United States
(12) Patent Application Publication
(10) Pub. No.: US 2018/0247349 A1
(43) Pub. Date: Aug. 30, 2018

(54) Invoice Issuing System and Invoice Issuing Method

(71) Applicant: Nippon Gas Co., LTD., Tokyo (JP)

(72) Inventors: Shinji Wada, Tokyo (JP); Shingo Dekamo, Tokyo (JP)

(21) Appl. No.: 15/876,067

(22) Filed: Jan. 19, 2018

Related U.S. Application Data
(63) Continuation-in-part of application No. 14/410,853, filed on Dec. 23, 2014, now abandoned.

(30) Foreign Application Priority Data
Jul. 4, 2012 (JP) 2012-150732

(51) Int. Cl. G06Q 30/04; G06Q 30/02

(52) U.S. Cl. CPC G06Q 30/04; G06Q 30/0284

(57) ABSTRACT

A delivery server includes: a receiving unit for receiving, from a mobile terminal, a gas meter reading processing request for a meter reading target; a calculation unit for performing meter reading processing depending on the request to calculate the gas fee of a customer based on the meter reading of the present month; a payment situation confirmation unit for confirming, from the payment situation of the storage unit, the gas fee payment situation of the customer prior to the meter reading of the present month based on the request to read, when the gas fee is unpaid, the unpaid gas fee from the management unit; an issuing unit for issuing invoice information including the gas fee based on the meter reading of the present month and the unpaid gas fee; and a transmission unit for transmitting the invoice information to the mobile terminal.

### CROSS-REFERENCE TO RELATED APPLICATIONS

This application is a continuation-in-part application of U.S. patent application Ser. No. 14/410,853 under 37 Code of Federal Regulations § 1.53 (b) and the said US application which is a US national phase of PCT Application No. PCT/JP2013/004111 on Jul. 2, 2013 claims the benefit of Japanese Patent application No. 2012-150732 filed on Jul. 4, 2012, which is hereby incorporated by reference in its entirety.

### TECHNICAL FIELD

The present invention relates to a system and a method for performing processing to invoice a gas fee.

### BACKGROUND ART

It is known that LP gas has been supplied by gas imported from gas-producing countries and gas as a byproduct of domestic process of petroleum oil products. An import base for storing LP gas transferred from gas-producing countries by a tanker and a petroleum oil purification base are called as a primary base. LP gas are loaded from the primary base to domestic vessels or tank lorries and is shipped to a secondary base that is located at a coast or an inland and that functions as a stopping base for LP gas transportation. The LP gas transported to the secondary base is transported to an LP gas filling station at each location (i.e., a delivery base) and is filled into a gas cylinder (gas bomb) at a delivery base.

The gas cylinders filled at the respective filling stations are delivered by a deliveryman to a customer's home (e.g., a standard home, collective housing, or office). An empty gas cylinder of the customer's home is exchanged with a filled gas cylinder and the empty gas cylinder is collected to a filling station. Each filling station has a fixed delivery area responsible for a deliveryman. A deliveryman receives delivery slips corresponding to 2 to 10 days showing delivery destinations to which gas cylinders should be delivered to customer's homes within the delivery area.

A delivery slip is prepared by a delivery manager. First, with regard to each customer, the amount of LP gas remaining in the gas cylinder is predicted based on the past gas usage, the meter indication of the gas meter of the customer's home, and the actually-delivered number. Then, the next delivery due date of gas cylinder(s) is determined. Integration is carried out for all customers within the delivery area responsible for the deliveryman to determine the delivery amount of gas cylinders corresponding to 2 to 10 days.

After the deliveryman exchanges the gas cylinder with the new one by the deliveryman based on the delivery slip, the deliveryman writes, into a delivery slip, the respective items of a date of exchange, the meter indication of the exchange date, the cylinder number, and the safety inspection. When the daily delivery operation is completed, the delivery slip is submitted to the delivery manager. The delivery slip returned to the delivery manager is checked for an incomplete form by the delivery manager and is subsequently stored as data used to calculate the next delivery due date. A system has been suggested to provide an efficient delivery of gas cylinders under a system as described above (see Patent Publication 1).

As disclosed in Patent Publication 1, a system gas for an efficient cylinder delivery has been conventionally provided. However, there have been no system that can charge a gas fee based on the execution of a gas meter reading together with an unpaid gas fee for which a fixed period has already passed since the previous invoice.

Generally, it has been known to charge a gas fee by a handy terminal not including a communication function. In this case however, it was required to check whether there is an unpaid gas fee or not by using a computer terminal other than the handy terminal to inquire of a server for the payment situation at the time. Furthermore, even when the computer terminal is used for an inquiry, the payment situation must be always updated. Therefore, if the inquiry timing does not concur with the charge timing, wrong charge details may be issued.

### CITATION LIST

### Patent Literature

PTL 1: Japanese Patent Laid-Open No. H08-329159 (1996)

### SUMMARY OF INVENTION

In view of the situation as described above, it is an objective of the present invention to provide an invoice issuing system and an invoice issuing method by which, when a gas meter reading is performed, a gas fee charge operation including the gas fee generated based on the meter reading and an unpaid gas fee can be carried out efficiently.

In order to solve the above problem, the present invention provides a gas fee invoice issuing system, comprising: a receiving unit for receiving, from a communication terminal, a gas meter reading processing request for a meter reading target; a calculation unit for performing meter reading processing depending on the request to calculate the gas fee of a customer based on the meter reading of the present month; a management unit for managing the gas fee payment situation of the customer; a payment situation confirmation unit for confirming, from the payment situation of the management unit, the gas fee payment situation of the customer prior to the meter reading of the present month based on the request to read, when the gas fee is unpaid, the unpaid gas fee from the management unit; an issuing unit for issuing invoice information including the gas fee based on the meter reading of the present month and the unpaid gas fee; and a transmission unit for transmitting the invoice information to the communication terminal.

In order to solve the above-described disadvantage, the present invention provides: a method of allowing a computer to issue a gas fee invoice, comprising: a step of receiving, from a communication terminal, a gas meter reading processing request for a meter reading target; a step of performing meter reading processing depending on the request to calculate the gas fee of a customer based on the meter reading of the present month; a step of managing the gas fee payment situation of the customer; a step of confirming, from the payment situation of the management unit, the gas fee payment situation of the customer prior to the meter reading of the present month based on the request to read, when the gas fee is unpaid, the unpaid gas fee from the management unit; a step of issuing invoice information including the gas fee based on the meter reading of the present month and the unpaid gas fee; and a step of transmitting the invoice information to the communication terminal.

According to the present invention, when a gas meter reading is carried out, a gas fee charge operation including the gas fee generated based on the meter reading and an unpaid gas fee can be carried out efficiently.

### BRIEF DESCRIPTION OF DRAWINGS

FIG. 1 is a network configuration example illustrating according to one embodiment of the present invention;

FIG. 2 is a block diagram of a configuration example of the delivery server of FIG. 1;

FIG. 3 illustrates a configuration example of customer information stored in the storage apparatus of the delivery server of FIG. 1;

FIG. 4A illustrates one example of information including the customer payment situation stored in the storage apparatus of the delivery server of FIG. 1;

FIG. 4B illustrates one example of information including the customer payment situation stored in the storage apparatus of the delivery server;

FIG. 5 is a flowchart illustrating an example of the entire operation of the delivery server according to one embodiment of the present invention;

FIG. 6 illustrates an example of indication data;

FIG. 7 is a configuration example illustrating a plurality of pieces of indication data stored in the storage apparatus of the delivery server of FIG. 1;

FIG. 8 illustrates an example of an invoice including a gas fee bill and the meter reading details;

FIG. 9 illustrates an example of a table including a gas type; and

FIG. 10 illustrates an example of a table of fees classified according to the type of gas.

### DESCRIPTION OF EMBODIMENTS

The following section will describe briefly the configuration of a system in this embodiment. This system performs a gas meter reading together with a gas fee invoicing operation.

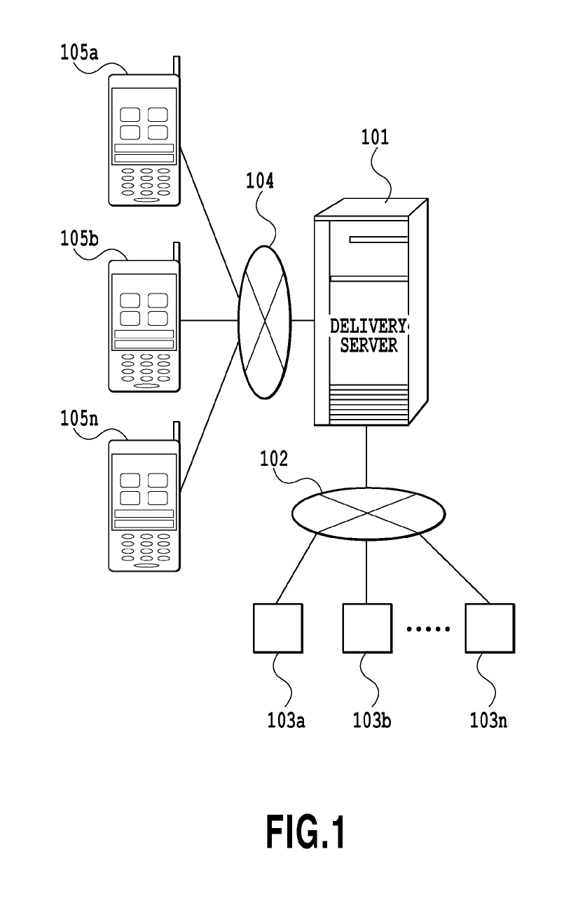

FIG. 1 illustrates a network configuration according to one embodiment of the invention. In FIG. 1, a delivery server (invoice issuing system) 101 is configured to be communicatively connected, via a network 102, to a plurality of payment computers 103a and 103b, . . . , 103n. This delivery server 101 is configured to be communicatively connected, via a network 104, to a plurality of mobile terminals (communication terminals) 105a, 105b, . . . , 105n. In the description common to the respective plurality of payment computers 103a to 103n, the respective payment computers will be simply referred to as a payment computer 103. In the description common to the respective plurality of plurality of mobile terminals 105a to 105n, the respective mobile terminals will be simply referred to as a mobile terminal 105.

The payment computer 103 is, for example, a computer for performing a gas fee payment for example and includes a CPU and a storage apparatus (not shown) for example. This payment computer 103 is connected to a delivery server 101 and notifies the delivery server 101 of the payment situation determined based on whether the payment is made or not for example. The payment types include, for example, the payment using a bill at a convenience store or a post office, an automatic bank debit through a bank account, the payment by a credit card, or an on-line electronic payment.

The mobile terminal 105 is a terminal that is used by a meter reader to confirm the meter indication of a gas meter attached to a piece of supply equipment including a gas cylinder and that includes, for example, CPU, memory, an input apparatus, and a display apparatus. The meter reader collects the indication data including the meter indication of the gas meter via the mobile terminal 105 to send the data to the delivery server 101.

### [Delivery Server Configuration]

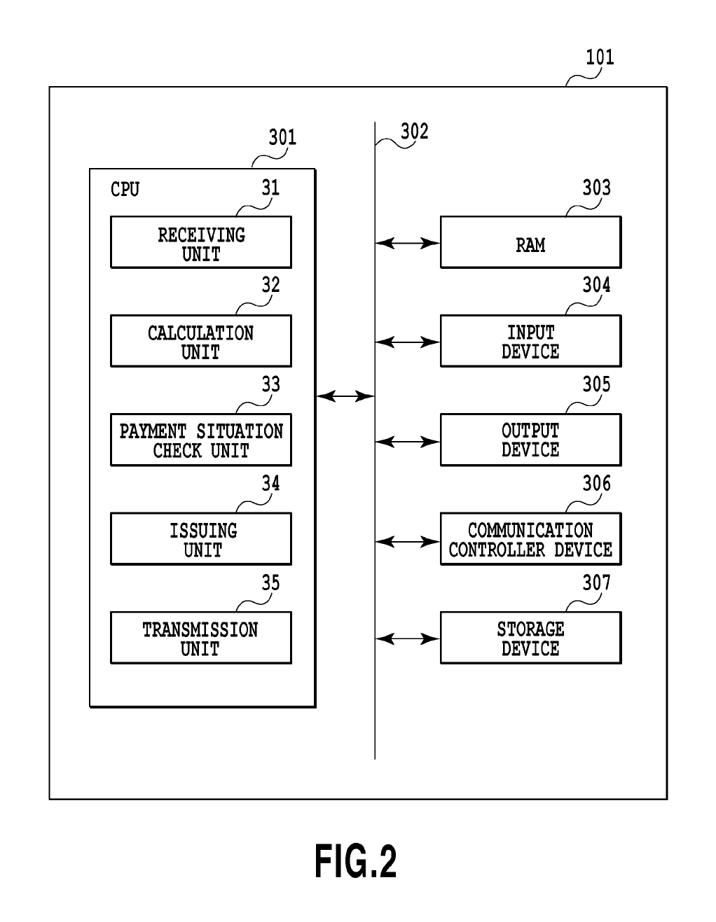

FIG. 2 is a block diagram illustrating a configuration example of the delivery server 101. In FIG. 2, a case will be described in which a single computer system is used. However, there also may be a case in which the delivery server 101 is configured as a part of a multi-functional distributed system composed of a plurality of computer systems.

As shown in FIG. 2, the delivery server 101 has: a CPU 301, a system bus 302, a RAM 303, an input apparatus 304, an output apparatus 305, a communication control apparatus 306, and a storage apparatus (management unit) 307.

The CPU 301 is connected to the respective components via the system bus 302 to perform processing to transfer a control signal or data and to perform the execution of various pieces of softwares for the operation of the entire delivery server 101 and calculation processing for example.

The RAM 303 includes a work area to temporarily store data and a software program.

The storage apparatus 307 is configured by a non-volatile storage medium such as ROM or HDD and includes a program storage region that stores a software program and a data storage region that stores data of continuously-stored data or processing result data for example. For example, a software program for example is read out from the program storage region of the storage apparatus 307 to the work area of the RAM 303 and the software program is carried out by the CPU 301, thereby allowing the CPU 301 of this embodiment to realize the functions of the respective parts 31 to 35 (which will be described later).

The CPU 301 includes, as shown in FIG. 2, a receiving unit 31, a calculation unit 32, a payment situation confirmation unit 33, an issuing unit 34, and a transmission unit 35.

The receiving unit 31 receives from the mobile terminal 105 a gas meter reading processing request for a meter reading target. In this embodiment, the meter reading processing request is performed using indication data including the meter indication showing a gas usage based on a gas cylinder and the meter reading date for example. The details of the indication data will be described later.

The calculation unit 32 performs the meter reading processing depending on the above-described request to calculate the gas fee of a customer based on the meter reading of the present month.

The calculation unit 32 performs the meter reading processing by performing, for example, the calculation of {(the meter indication of the present meter reading date)−(the meter indication of the previous meter reading date)} to calculate the gas usage in a period from the previous meter reading date to the present meter reading date. After the calculation of the gas usage, the calculation unit 32 calculates, based on a predetermined calculating formula (e.g., (basic fee)+(unit fee)×(gas usage)), the gas fee of a customer based on the meter reading of the present month. Specifically, the gas fee of the customer based on the meter reading of the present month is, for example, the gas fee for the gas usage in a period from the previous meter reading date to the present meter reading date. The above-described method of calculating the gas fee is not limited to the above-described example and can be performed from various points of view.

The payment situation confirmation unit 33 confirms, based on the payment situation of the storage apparatus (management unit) 307 for managing the gas fee payment situation of the customer, the gas fee payment situation prior to the meter reading of the present month for the customer calculated by the calculation unit 32 based on the request received by the receiving unit 31. The payment situation managed by the storage apparatus 307 will be described in detail later.

When the confirmation by the payment situation confirmation unit 33 results in that the gas fee is unpaid, then the payment situation confirmation unit 33 reads the unpaid gas fee from the storage apparatus 307.

The issuing unit 34 issues invoice information including the gas fee based on the meter reading of the present month calculated by the calculation unit 32 and the unpaid gas fee read by the payment situation confirmation unit 33.

The transmission unit 35 sends, to the mobile terminal 105, the invoice information issued by the issuing unit 34. The invoice information includes the gas fee based on the meter reading of the present month for example and the details thereof will be described later.

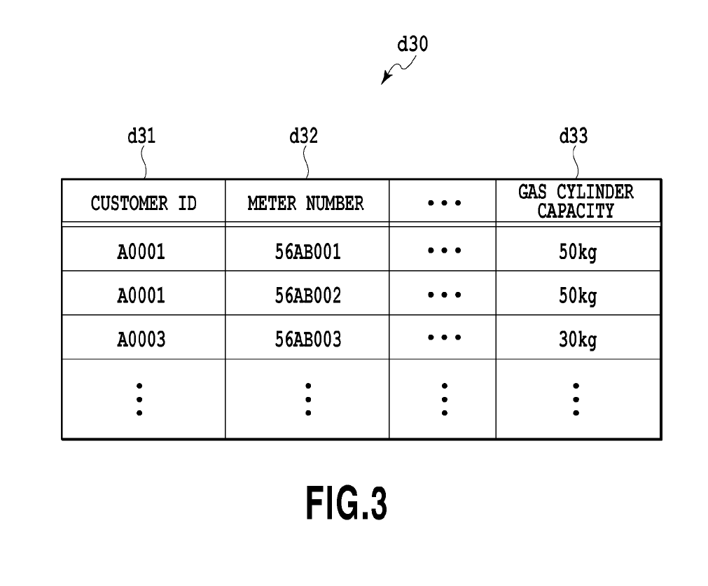

FIG. 3 illustrates a configuration example of customer information d30 stored in the storage apparatus 307 of the delivery server 101. As shown in FIG. 3, the storage apparatus 307 stores therein a “customer ID” d31 for identifying a customer, a “meter number” d32 for identifying a gas meter, and a “gas cylinder capacity” d33 for example.

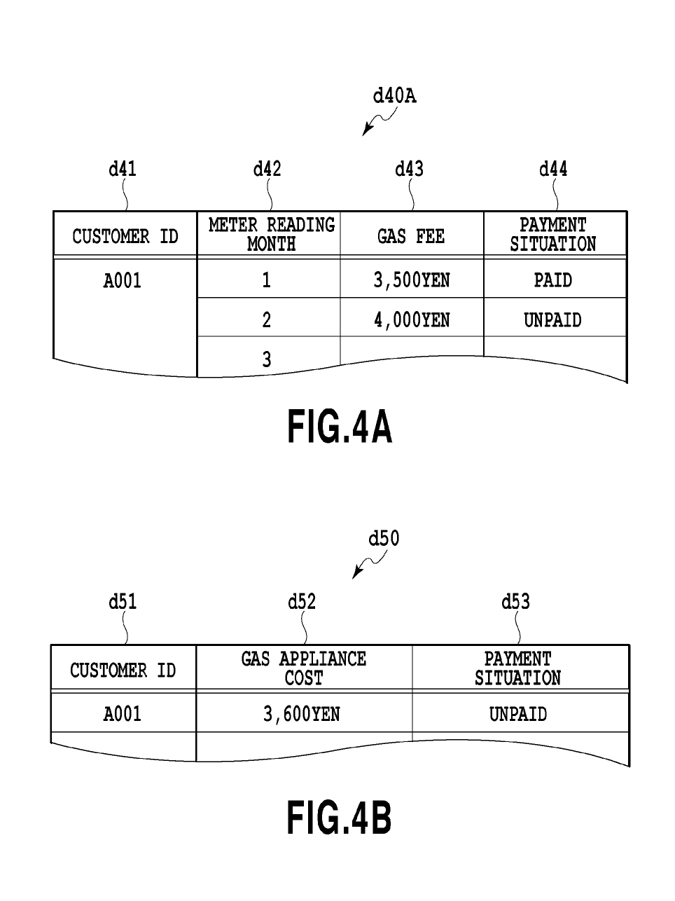

FIG. 4A and FIG. 4B illustrate an example of information including the customer payment situation stored in the storage apparatus 307 of the delivery server 101. FIG. 4A illustrates a table storing the gas fee payment situation. FIG. 4B illustrates a table storing the gas appliance payment situation.

The table d40A of FIG. 4A stores the above-described “customer ID” d41, the “meter reading month” d42, the “gas fee” d43, and the “payment situation” d44. In one example of the table d40A of FIG. 4A, a customer having the customer ID “A001” is set to have “3500 yen” as a gas fee corresponding to the present month of “January” and a record is provided to show that this gas fee is already “paid”. By this configuration, whether each customer has paid each gas fee based on the meter reading of the present month is managed.

The table d50 of FIG. 4B stores the above-described “customer ID” d51, the “gas appliance cost” d52, and the “payment situation” d53. The gas appliances include, for example, a gas cooking appliance, a gas heater, and a gas fan heater.

In one example of the table of FIG. 4B, a customer having the customer ID “A001” is set to have the gas appliance cost of “3600” yen and a record is provided to show that this cost is “unpaid”. Thus, the gas appliance cost payment situation including the customer payment situation is managed.

The “payment situations” d44 and d53 in the table of FIG. 4A or FIG. 4B are set to be “paid” when the delivery server 101 receives notification from the payment computer 103. Specifically, the payment computer 103 sends to the delivery server 101, after performing the payment of the gas fee or the gas appliance cost, information for notifying the payment (e.g., the customer ID, the payment date, the meter reading month of the paid gas fee, or the gas appliance cost). As a result, the delivery server 101 changes the corresponding “payment situations” d44 and d53 in the tables d40 and d50 of FIG. 4A or FIG. 4B from “unpaid” to “paid”.

### [Operation of Delivery Server]

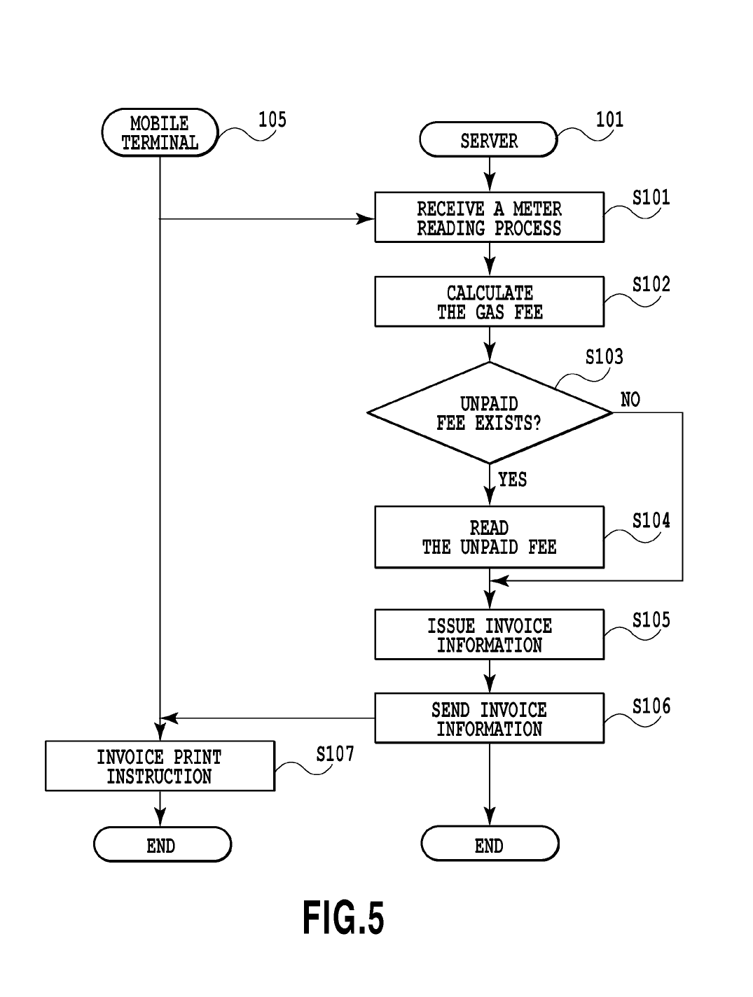

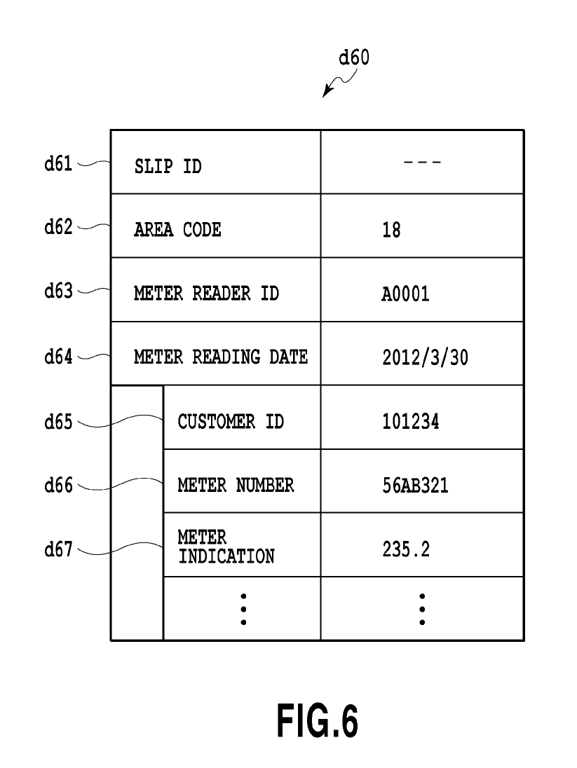

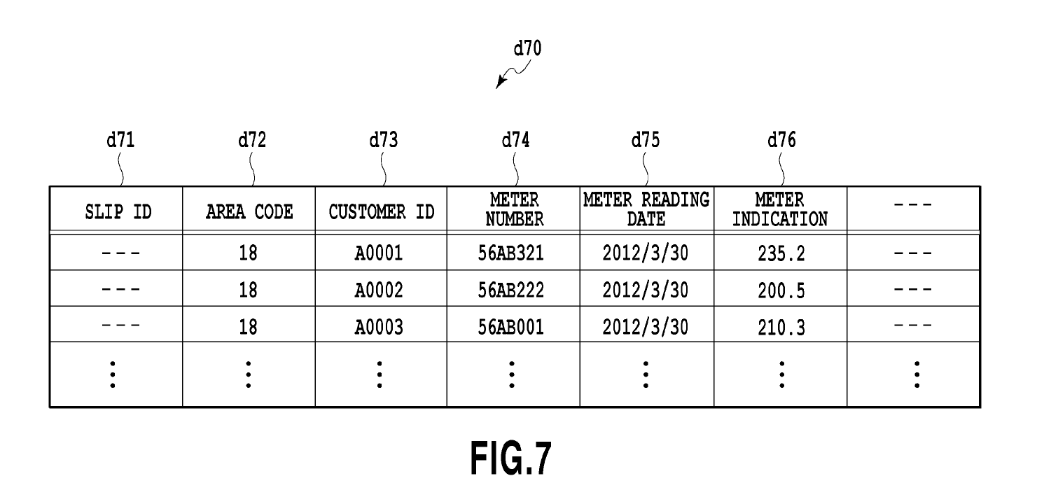

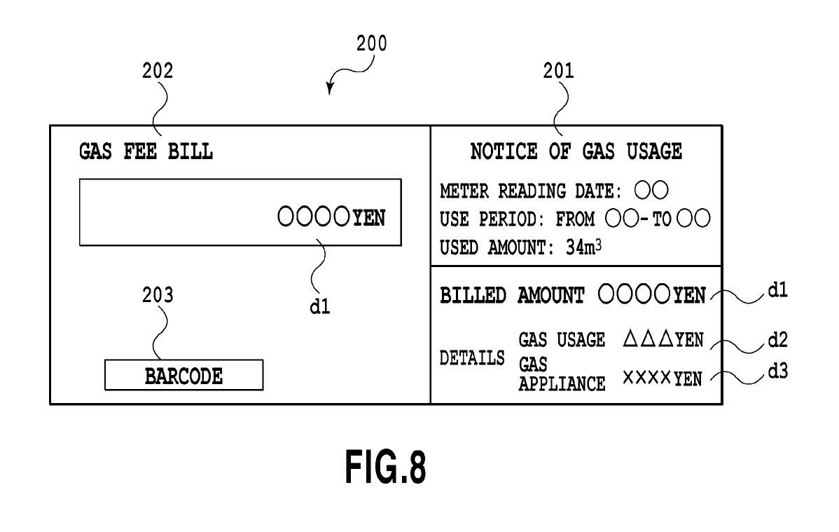

Next, the following section will describe a method of invoicing a gas fee when a gas meter reading is performed. FIG. 5 is a flowchart illustrating an example of the entire operation of the delivery server 101. FIG. 6 illustrates an example of the indication data of the gas meter. FIG. 7 illustrates a configuration example of a plurality of pieces of indication data stored in the storage apparatus 307 of the distribution server 101. FIG. 8 illustrates an example of an invoice.

In FIG. 5, when the mobile terminal 105 firstly sends a gas meter reading processing request for a meter reading target to the delivery server 101, then the request is received by the CPU 301 (receiving unit 31) of the delivery server 101 (S101). This request is performed, as shown in FIG. 6, using indication data including a meter reading slip ID d61, an area code d62, a meter reader ID d63, a meter reading date d64, a customer ID d65, a meter number d66, and a meter indication d67 for example.

In this embodiment, the gas meter is attached with a QR Code® (readable information code). Thus, the mobile terminal 105 can read the QR Code® to acquire the respective pieces of indication data except for the meter indication and the meter reading date. The meter indication shown in FIG. 6 is acquired based on an input operation of a meter reader for example and the meter reading date is a date on which the QR Code® is read for example.

When the CPU 301 (receiving unit 31) of the delivery server 101 receives from the mobile terminal 105 the request using the indication data on the meter reading date, then the CPU 301 stores the indication data in the storage apparatus 307. This storage example is shown in FIG. 7. As shown in FIG. 7, the database d70 of the storage apparatus 307 stores a plurality of pieces of indication data received by the CPU 301.

Upon receiving the above-described request, the CPU 301 (calculation unit 32) of the delivery server 101 performs meter reading processing depending on the request to calculate the gas fee of the customer based on the meter reading of the present month (S102).

In this meter reading processing, the gas usage is calculated based on the indication data on the present meter reading date (e.g., March 30) used in the request in S101 and the indication data used in the request received on the previous meter reading date (e.g., February 28). The storage apparatus 307 stores the indication data on the previous meter reading date (FIG. 7). Thus, the CPU 301 reads the indication data on the previous meter reading date from the storage apparatus 307.

The meter reading processing in S102 is performed, for example, by performing {(the meter indication included in the indication data of the present meter reading date)−(the meter indication included in the indication data of the previous meter reading date)} to calculate the gas usage corresponding to a period from the previous meter reading date to the present meter reading date. Based on the gas usage, the CPU 301 calculates the gas fee of the customer based on the meter reading of the present month. In this embodiment, the gas fee of the customer based on the meter reading of the present month is set to be an amount calculated, for example, based on a formula of (basic fee)+(unit fee)×(gas usage) (e.g., 5000 yen).

Furthermore, in S103 of FIG. 5, the CPU 301 (payment situation confirmation unit 33) of the delivery server 101 refers to the table of FIG. 4A for example to determine whether the customer has an unpaid fee or not. With reference to FIG. 4A, the customer having the customer ID A001 has an unpaid gas fee corresponding to two months. Thus, this customer is determined as having an unpaid fee (“Yes” in S103). In this case, the CPU 301 reads from the table of FIG. 4A the unpaid fee corresponding to the customer ID (e.g., 4000 yen) (S104).

Furthermore, in the processing to determine whether there is an unpaid fee in S103, the CPU 301 (the payment situation confirmation unit 33) also may refer to the table of FIG. 4B for example to determine whether the customer has an unpaid fee (or an unpaid gas appliance cost) or not. With reference to FIG. 4B, the customer having the customer ID A001 has an unpaid gas appliance cost of 3600 yen. Thus, the CPU 301 reads the unpaid cost (e.g., 3600 yen) from the table of FIG. 4B (S104). When there is no unpaid fee in the determination in S103 (“No” in S103, then the processing proceeds from S103 to S105.

Next, the CPU 301 (issuing unit 34) of the delivery server issues the invoice information including the gas fee calculated in S102 based on the meter reading of the present month (e.g., 5000 yen) and the unpaid fee read in S104 (e.g., 4000 yen). Furthermore, in this embodiment, since the gas appliance cost of 3600 yen is unpaid for example, the CPU 301 causes the invoice information to include this unpaid gas appliance cost.

Then, the CPU 301 (transmission unit 35) sends this invoice information to the mobile terminal 105 (S106).

When the mobile terminal 105 receives the above-described invoice information, the mobile terminal 105 instructs a printer (not shown) for example to print an invoice based on this information (S107). As a result, the printer 1 is caused, as illustrated in FIG. 8, to print the invoice 200 including the gas usage notice 201 showing the meter reading details and the gas fee payment slip 202. In the example of the meter reading details 201 of FIG. 8, the total billed amount d1(=d2+d3) is printed that is obtained by adding the gas fee d1 corresponding to the gas usage (in this embodiment, the total of d1=the gas fee corresponding to the meter reading of the present month (e.g., 5000 yen)+the unpaid gas fee corresponding to the previous month meter reading (e.g., 4000 yen)) and the unpaid gas appliance cost d2 (e.g., 5000 yen)).

In the example of the gas fee bill 202 of FIG. 8, the gas fee bill 202 includes the above-described billed amount d1 and a barcode 203 and is printed based on a format to enable the payment based on previously-specified payment methods (payment at a convenience store or at a post office). In this case, the previously-specified payment methods are stored in the storage apparatus 307 to be associated with the customer ID. In the processing of S105 of FIG. 5 to issue invoice information, the CPU 301 reads the payment method corresponding to the customer ID to issue invoice information including the payment method. As described above, an operation is performed to issue an invoice regarding the gas fee or the gas appliance.

As described above, during the gas meter reading, the delivery server 101 of this embodiment sends, to the mobile terminal 105, the invoice information including the present month meter reading and the unpaid gas fee. Thus, the meter reading operation and the invoicing operation can be performed simultaneously, thus achieving an efficient operation to invoice a gas fee including an unpaid gas fee.

Furthermore, since the invoice information includes an unpaid gas appliance cost also, an invoicing operation to customers can be carried out more efficiently.

As described above, an embodiment has been described. However, a specific data structure for example is not limited to the embodiment and also may be changed. For example, in S104 of FIG. 5, an example was shown in which an unpaid fee is read when such an unpaid fee exists. However, another configuration also may be used in which an unpaid fee is read only when an unpaid period is longer than a predetermined period (e.g., one week has passed since the payment deadline).

A case was described in which the invoice 200 included the meter reading details 201 and the bill 202. However, the invoice 200 may be printed in arbitrary layout, format, and contents so long as customers can be notified of the gas fee charge details generated during a gas meter reading that include the gas fee based on the meter reading of the present month and the unpaid gas fee. For example, the meter reading details 201 and the bill 202 may be printed separately so that only the bill 202 is handled as the invoice 200.

### Modification Example 1

Description has not provided above for replacement of a gas meter. However, at the time of meter reading processing after the replacement of the gas meter, a situation for a gas fee payment may be determined and then information for charging an unpaid fee may be provided.

Next, explanation will be provided for an exemplary action of the server 101 for achievement of the above process.

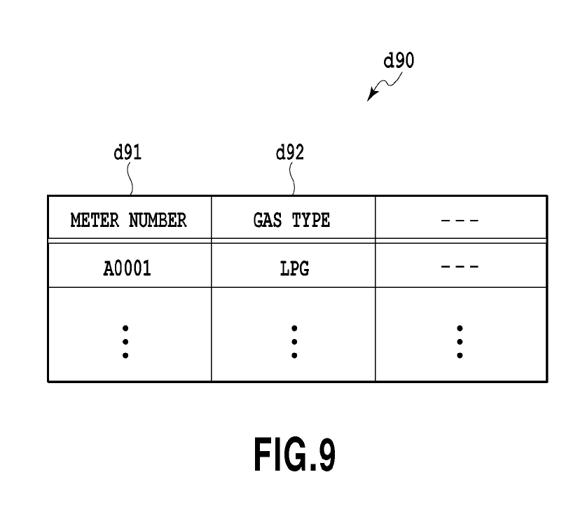

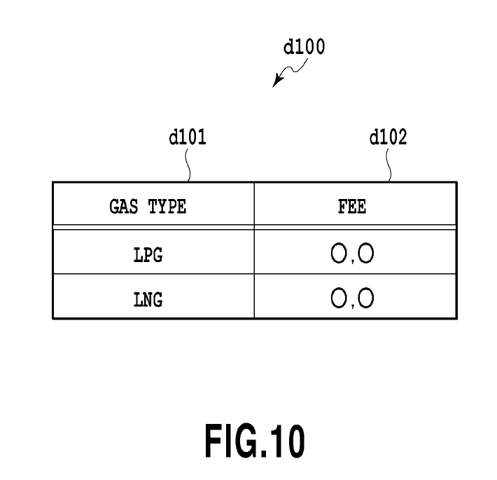

Firstly, with reference to FIGS. 9 and 10, explanation will be provided for data processed within the server 101 (master data of a gas meter and data on a gas type).

FIG. 9 illustrates an exemplary table d90 with a gas type to be described below. The table d90 is stored by the storage apparatus 307.

In the example of the table d90, as shown in FIG. 9, items such as a meter number d91, a gas type d92, and so forth are associated with each other. The meter number d91 of FIG. 9 is identical to the meter number d32 of FIG. 3.

As an example, a gas type indicating Liquefied Petroleum Gas (LPG), Liquefied Natural Gas (LNG), or so forth is set as an item of the gas type d92.

FIG. 10 illustrates an exemplary table d100 of fees classified according to the type of gas. The table d100 is stored by the storage apparatus 307.

As shown in FIG. 10, a gas type d101 and a fee d102 stored in the table d100 are associated with each other. The gas type d101 of FIG. 10 is identical to the gas type d92 of FIG. 9. Examples of a fee to be set as a value of the fee d102 include a basic fee and a unit fee.

Next, with reference to FIGS. 2, 4A, 5, 8 to 10, explanation will be provided for the process performed after the replacement of a gas meter described above.

For example, when a gas to be supplied to a customer is changed from “LPG” to “LNG,” the customer's gas meter should be replaced. That is, the gas meter for “LPG” (existing one) is replaced with a gas meter for “LNG” (new one). In this case, in the process of FIG. 5, the CPU 301 receives a meter reading processing request of the gas meter for “LNG” on a meter reading date (step S101). In this modification example, the CPU 301 also uses indication data d60 of FIG. 6, and receives information relating to the new gas meter for “LNG” from the mobile terminal 105. In this case, the indication data d60 of FIG. 6 includes a “meter number” corresponding to the gas meter for “LNG.” The CPU 301 receives information on the gas meter for “LNG” installed after the replacement (for example, a slip ID d61, an area code d62, a meter reader d63, a meter reading date d64, a customer ID d65, a meter number d66, a meter indication d67 and so forth).

Next, the CPU 301 calculate a gas fee in the same manner as in the processing in step S102 of FIG. 5 by using the indication data of the gas meter for “LNG”. In the modification example, the type of the gas used after the replacement of the existing gas meter is different from that of the new one. The CPU 301 reads fee data corresponding to the gas type “LNG” from the table d100 of FIG. 10 before the calculation. In this case, firstly, the CPU 301 determines, for instance, the gas usage in a period from the replacement of a gas meter to the present meter reading date based on formula (1) of (the meter indication included in the indication data of the new gas meter for which the request has been received in S101)−(the meter indication of the new gas meter at the time of replacement). It should be noted that the meter indication of the new gas meter at the time of the replacement is stored in the storage apparatus 307 in advance. The CPU 301 reads the meter indication, and then refers to the table d90 of FIG. 9 to identify the gas type “LNG” corresponding to the meter number. The CPU 301 refers to the table d100 of FIG. 10 to determine a gas fee based on meter reading processing of the new gas meter by using a fee corresponding to the gas type “LNG.” For example, the gas fee is determined based on formula (2) of (basic fee for “LNG”)+(unit fee for “LNG”)×(gas usage determined based on formula (1) above).

Furthermore, in FIG. 5, the CPU 301 determines the customer payment situation at the time of the meter reading processing of the gas meter for “LPG” used before the replacement based on information related to the payment situation d44 of the gas fee (“paid” or “unpaid”) in the table d40A of FIG. 4A (step S103). When the customer has an unpaid fee, the CPU 301 reads the gas fee at the time of the meter reading processing of the gas meter for “LPG” (step S104). Next, the CPU 301 generates, as information for charging the customer, the gas fee applied on the present meter reading date when the gas meter for “LNG” is used (the processing result of S102) and the gas fee read in step S104 at the time of the meter reading processing of the gas meter for “LPG” (step S105). The CPU 301 outputs the information to the mobile terminal 105 (step S106). This allows the mobile terminal 105 to receive the information from the server 101 and print the information as shown in the example of FIG. 8.

By performing such a process, information for use in gas fee payment can be provided, for instance, at the time of a monthly gas meter reading, even if an existing gas meter is replaced with a new gas meter which handles a different type of gas.

### REFERENCE SIGNS LIST

31 Receiving unit
32 Calculation unit
33 Payment situation confirmation unit
34 Issuing unit
35 Transmission unit
101 Delivery server
105 Mobile terminal
301 CPU
307 Storage apparatus

1. A system for performing meter reading processing of a gas meter that detects a gas usage, comprising:
a memory for managing indication data of the gas meter; and
a processor connected to the memory, the processor is configured to receive, from a communication terminal when the gas meter is replaced, a meter reading processing request for a new gas meter used after the replacement, the new gas meter handles a different gas from an existing gas meter used before the replacement, the memory stores fee data corresponding to a gas type, the processor is, before the replacement of the existing gas meter, configured to:
store, in the memory, information related to a customer payment situation of a gas fee charged based on meter reading processing of the existing gas meter;
read, from the memory, fee data corresponding to a gas type used with the new gas meter and use the fee data to calculate a gas fee in meter reading processing of the new gas meter;
determine the customer payment situation in the meter reading processing of the existing gas meter based on the information relating to the payment situation of the gas fee stored in the memory; and
output to the communication terminal, when the customer has an unpaid fee, information for use in charging the customer the gas fee based on a present meter reading date when the new gas meter is used and the gas fee in the meter reading processing of the existing gas meter.
